(19) United States
(12) Patent Application Publication
(10) Pub. No.: US 2010/0320188 A1
(43) Pub. Date: Dec. 23, 2010

(54) SALT STONE WARMER

(76) Inventor: Michael Gallagher, Evansville, IN (US)

Correspondence Address: Brannon & Sowers PC, 1 North Pennsylvania Street, Suite 520, Indianapolis, IN, 46204, US

(21) Appl. No.: 12/821,934

(22) Filed: Jun. 23, 2010

Related U.S. Application Data
(60) Provisional application No. 61/269,312, filed on Jun. 23, 2009.

(51) Int. Cl. H05B 3/00

(52) U.S. Cl. 219/385

(57) ABSTRACT

A salt stone warmer apparatus designed to warm the salt stones and clean and ionize the air and add to the aesthetics of any massage, spa or salon room. The warmer includes a base member having a wall that defines a cavity having a flat heating surface and a central bore. A heating means is mounted to the heating surface within the cavity. The base member further includes a bottom surface having a plurality of support legs to raise the warmer above the countertop surface.

### CROSS REFERENCES TO RELATED APPLICATIONS

This application claims priority to copending U.S. Patent Application Ser. No. 61/269,312 filed on Jun. 23, 2009.

### BACKGROUND OF THE INVENTION

1. Field of the Invention

This invention relates generally to salt stone therapy and more particularly to a warming apparatus for self-applied salt stone therapy.

2. Brief Description of Prior Art

Salt stones are anti-microbial ant naturally limit the growth of bacteria and other potentially harmful microbes. Salt stones are compromised of pure crystals that can be used in energy modalities such as reiki, and used in such disciplines as acupuncture, reflexology and the like. In addition, warming the salt stone releases large quantities of healthy negative ions (anions) that improve the quality and freshness of the air. Negative ions, clean the air of dust, pollen (grass, wheat and tree pollen), animal dander, smoke, odor, and mold spores. They are further known to reduce symptoms of hay fever, asthma, depression and chronic fatigue.

What is needed, then, is a salt stone warmer that is portable, simple and low cost. This apparatus is presently lacking in the prior art.

As will be seen from the subsequent description, the preferred embodiments of the present invention overcomes shortcomings of the prior art.

### SUMMARY OF THE INVENTION

A salt stone warmer apparatus that is designed to warm the salt stones and clean and ionize the air and add to the aesthetics of any massage, spa or salon room. The warmer generally includes a base member having a wall that defines a cavity having a flat heating surface and a central bore. The wall includes an upper edge that defines a ledge for placement of an outer edge of a salt stone. A heating means is mounted to the heating surface with the cavity. Wiring for the heating means enters through the central bore of the base member. The base member includes a bottom surface having a plurality of support legs to raise the warmer above the countertop surface.

In application, the salt stone is placed on the upper edge of the base member such that the edge of the salt stone rests on the ledge of the base member providing an air space for placement of the heating means within the cavity and below the salt stone.

### BRIEF DESCRIPTION OF THE DRAWINGS

FIG. 1 is a side view of the present invention, a salt stone warmer with a salt stone thereon.

FIG. 2 is a top view of the salt stone warmer of FIG. 1 without the salt stone.

### DESCRIPTION OF THE INVENTION

In accordance with the present invention, a salt stone warmer apparatus is disclosed. The salt stone warmer apparatus is primarily directed to a warming apparatus which cooperates with a salt stone in order to warm the stone. The salt stone warmer of the present invention is especially designed to provide a portable low cost apparatus for warming salt stone to clean and ionize the air and add to the aesthetics of any room. In the broadest context, the salt stone warmer of the present invention consists of components configured and correlated with respect to each other so as to attain the desired objective.

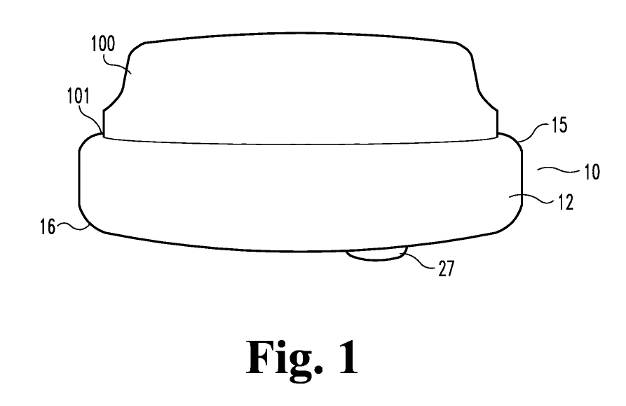

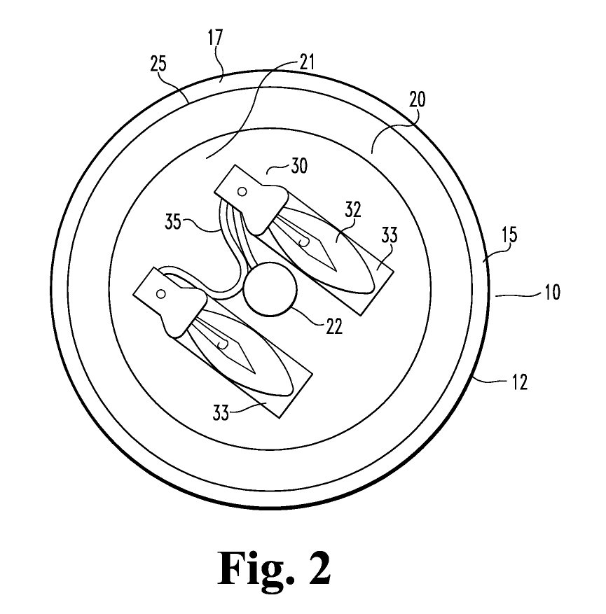

FIGS. 1-2 illustrate a preferred embodiment of a salt stone warmer apparatus made in accordance with the present invention. The apparatus of the invention designated as numeral 10 generally includes a base member 12 having a wall 15 that defines a cavity 20 having a flat heating surface 21. The cavity 20 further includes a central bore 22.

The wall 15 includes an upper edge 17 that defines a ledge 25 for placement of an outer edge 101 of a salt stone 100.

The apparatus 10 further includes a heating means 30 that is mounted 33 generally centrally to the surface 21 of the base member 12. In the preferred embodiment, the heating means 30 is at least one (1) incandescent light bulb 32 for warming and illuminating the salt stone 100. As such, the at least one (1) incandescent light bulb 32 illuminates the salt stone 100 for display purposed and heats the salt stone 100 for the anti-microbic benefits described.

Wiring 35 for the heating means 30 enters through the central bore 22 of the base member 12. Preferably, the heating means 30 is the controllable so that a selected constant temperature can be maintained. This feature would be especially appreciated when used a salt de-toxer for hands and feet.

It should be noted that the depth of the cavity 20 is such that the heating means 30 is within the cavity 20 and adjacent the ledge 25.

The base member 12 further includes a bottom surface 16 having a plurality of support legs 27, if desired, to raise the warmer above the countertop surface. However, the embodiments described permits placing the warmer 10 on the countertop surface even when support legs are not employed.

As illustrated, the base member 12 and salt stone 100 have substantially similar configurations. In preferred embodiment, both are substantially circular and have diameters substantially equal. However, other shapes and configurations may be utilized within the scope of the invention.

In this application, the salt stone 100 is placed on the upper edge 17 of the base member 12 such that the edge 101 of the salt stone 100 rests on the ledge 25 of the base member 12 providing an air space therein. This air space permits placement of the heating means 30 below the salt stone 100 and within the cavity 20.

Although the description above contains many specificities, these should not be construed as limiting the scope of the invention but is merely providing all illustrations of some point of the present preferred embodiments of this invention. For example, while the specification describes the warming apparatus 10 used in association with salt stone, it should be understood that apparatus would be especially useful as a food warmer or candle warmer for example. Thus, the scope of the invention should be determined by the appended claims in the formal application and their legal equivalence, rather than by the examples given.

I claim:

1. A salt stone warmer, compromising:
a base member having a wall that defines a cavity having a flat heating surface and a central bore, said wall includes an upper edge that defines a ledge for placement of an outer edge of a salt stone,
a heating means mounted to the heating surface,
wiring for the heating means enters through the central bore of the base member,
said base member further includes a bottom surface having a plurality of support legs to raise the warmer above a countertop surface.

2. A salt warmer, comprising:
a recessed base portion;
a heater positioned in the recessed base portion;
a power source operationally connected to the heater;
a salt body positioned on the base portion;
wherein energization of the heater raises the temperature of the salt body;
wherein energization of the heater increases the rate at which salt ions are introduced into the surroundings; and
wherein energization of the heater illuminates the salt body.
